(19) United States
(12) Patent Application Publication
(10) Pub. No.: US 2022/0153556 A1
(43) Pub. Date: May 19, 2022

(54) VACUUM LIFTING DEVICE

(71) Applicant: FIPA Holding GmbH, Ismaning (DE)

(72) Inventors: Michael KALTENECKER, Munich (DE); Christopher JOST, Moosinning (DE); Michael STOLZE, Buch am Buchrain (DE)

(21) Appl. No.: 17/433,053

(22) PCT Filed: Feb. 25, 2020
(86) PCT No.: PCT/EP2020/054823

§ 371 Date: Aug. 23, 2021

(30) Foreign Application Priority Data
Feb. 26, 2019 (DE) 10 2019 104 807.9

(51) Int. Cl. B66C 1/02

(52) U.S. Cl. CPC B66C 1/0256

(57) ABSTRACT

The invention relates particularly to a vacuum lifting device comprising a sensor system for the direct or indirect determination or estimation of the type and/or weight of goods gripped or to be gripped by a suction means of the vacuum lifting device.

The present invention relates in general particularly to vacuum technology-based gripping systems for the dynamic handling of objects. Specifically, the invention relates to a vacuum lifting device which is sometimes also referred to as a “suction lifter.”

In such a vacuum lifting device, the lifting and holding of different workpieces ensues with the aid of a vacuum. The lifting process is rendered possible by a variable-length suction hose, for example in the form of a spiral tube. This variable-length suction hose is sometimes also referred to as a “lifting tube.”

A load-handling means which can either be realized as a primarily vacuum-operated suction means or as mechanical gripping means is attached to the end of the variable-length suction hose.

Upon a suction means being placed on the workpiece to be moved, the air contained in the suction means and the variable-length suction hose is at least partially evacuated, in consequence of which the variable-length suction hose contracts like an accordion such that the workpiece clings to the suction means and can ultimately be lifted. When the vacuum decreases, the load is then lowered again.

Depending on the application, the vacuum is either generated by a side channel blower, a vacuum pump or a multi-chamber eductor (Venturi nozzle).

An operating element attached to the lower end of the variable-length suction hose is generally used to manually control the vacuum lifting device. This operating element enables the one-handed control of the suctioning, lifting, lowering and subsequent release of the load.

According to one aspect of the present invention, same in particular relates to a vacuum lifting device having a suction line extending between a vacuum connection of a vacuum supply and an outlet opening. The vacuum lifting device further comprises a load-handling means such as a suction means, for example, which serves the sealing engagement with surfaces of the transport item and which is attached to one side of the suction line and delimits the outlet opening.

A variable-length suction hose is further employed which limits the suction line at least in some areas between the suction means and the vacuum connection. Lastly, a valve control is provided which is designed to set a negative pressure in the suction hose as well as influence a free flow cross-section of the suction line within a section of line between the suction hose and the outlet opening and which is adjustable between a closed position for interrupting the line section and an open position for unblocking the line section (manually).

Such a vacuum lifting device is—at least in principle—already known from the prior art. For example, the DE 10 038 013 B4 printed publication relates to a vacuum lifting device which serves in the lifting of transport items such as boxes, drums or bags. The vacuum lifting device known from this prior art comprises a vertically extending variable-length suction hose, the upper end of which can be fixed to a support or the wall of a building. An operating element in which a valve device is disposed is attached to the lower end of the variable-length suction hose. The operating element is coupled to a plate-like suction means provided with a circumferential elastic seal. The suction cup-like suction means serves the sealing engagement with the surface of a transport item. A fluid chamber formed by the suction means and the transport item surface can thereby be brought into communicating connection with the pressurizable suction hose by the appropriate activation of the valve device. With the simultaneous, at least almost complete, sealing engagement of the suction means with the transport item surface, the negative pressure acting on the suction hose also leads to a negative pressure acting on the fluid chamber and thus to a suction force being exerted on the transport item. The negative pressure also acts on the suction hose and leads to a negative pressure-induced contraction of the suction hose length, resulting in lifting motion for the transport item.

In order to influence the speed of the lifting motion and the lifting height as well as to set the transport item down, the valve device enables the feed of supply air from the environment into the suction hose. This ensues by the valve device being able to govern a free cross-section of a supply air duct connecting the interior of the suction hose subjectable to negative pressure to the environment between an open position and a closed position. A maximum flow of supply air in the suction hose is able to occur in the open position; in the closed position, the flow of supply air in the suction hose is at least almost completely cut off. To set the transport item down, the negative pressure in the suction hose is first weakened by introducing supply air into the suction hose through the supply air duct. As a result, the variable-length suction hose lengthens due to the weight force of the transport item since same is no longer fully compensated by the negative pressure in the suction hose, and this continues until the transport item can be set down onto a surface. The suction means subsequently lifts from the surface of the transport item upon a maximum flow of supply air in the suction hose and thus minimal negative pressure in the suction hose and suction means.

The known vacuum lifting device comprises a control valve accompanying the valve device which is designed to temporarily interrupt a line section of the suction line formed between the suction means and the vacuum connection arranged at the upper end of the variable-length suction hose. When the suction means approaches the surface of the transport item, the control valve clears the line section of the suction line and thus the communicating connection between the vacuum connection and the suction means. Upon the exceeding of a predefinable distance between the suction means and the transport item surface, the control valve closes the suction line so as to prevent an unwanted negative pressure flow through the suction line toward the vacuum connection.

Instead of a plate-like suction means, a grid-like frame having multiple suction cups distanced from each other can also be provided as suction means at the lower end of the variable-length suction hose. A suction means of this type is used for the handling of wooden, glass or metal plates, for example, and is of considerable weight. Due to its spatial expansion, a suction means designed as such causes certain difficulties when lifting from transport item surfaces following completion of the lifting process.

The task of the invention consists of specifying a vacuum lifting device, particularly a vacuum lifting device of the aforementioned type, which is in particular clearly operator-friendly and enables fast and fluid work. The vacuum lifting device should in particular be readily adaptable to individual, user-specific problems. In addition, resources should be able to be conserved during the operation of the vacuum lifting device, particularly energy/vacuum.

Inventively proposed to this end is for the vacuum lifting device to comprise a sensor system for the direct or indirect determination or assessment of the type and/or weight force of a transport item which will be or is gripped by the suction means. By inventively determining or assessing the type and/or weight force of a transport item gripped or to be gripped by the suction means, it is possible, preferably automatically, for optimal vacuum lifting device parameters relevant to handling a transport item to be selected for each detected type of transport item, or for each detected weight of the transport item respectively, and for the corresponding associated process parameters to be set. The optimal adapting of the vacuum lifting device's operating parameters able to be achieved in this way can in particular reduce the consumption of energy while simultaneously enabling fast and fluid work with the vacuum lifting device.

The adjustable operating parameters of the vacuum lifting device relate for example to the operating mode or the type of vacuum source used for the vacuum supply able to be optimally adapted or selected in economic terms, particularly with regard to the weight of the transport item to be lifted by the vacuum lifting device.

Primarily to be understood as the “type of transport item” is in particular the type of workpiece/transport item to be manipulated by the vacuum lifting device. The transport item type depends in particular on e.g. the size, shape, material and weight of the transport item which will be or is gripped.

One conceivable implementation of the inventive solution provides for at least the following transport items being able to be recognized on the basis of the detected transport item type:
sheets made of wood or a wood-like material;
sheets made of metal or a metal-like material;
sheets made of glass or a glass-like material;
boxes;
cases; and
bags.

The invention is based on the knowledge that advantageous with respect to fast and fluid work while simultaneously conserving resources is for the relevant functionalities and/or operating parameters of the vacuum lifting device to be able to be adjusted subject to the type of transport item and/or the weight force of the gripped or to be gripped transport item. For example, upon detecting that the gripped or to be gripped transport item is a transport item of high weight force, the vacuum source for the vacuum supply of the vacuum lifting device is to be activated/selected accordingly; respectively, upon detecting or determining that the gripped or to be gripped transport item is a transport item of relatively low weight force, the vacuum source is to be activated/selected accordingly.

The same also applies figuratively to transport items having surfaces of non-constant sealing as can be the case with boxes or bags, for example.

Moreover of advantage is the initiating/activating of further additional functionalities of the vacuum lifting device when it is assessed or determined that the gripped or to be gripped transport item is a particularly bulky transport item such as for example a plate or the like.

Such an additional functionality could for example comprise using a sensor system to detect the position of the vacuum lifting device and/or movement data of the vacuum lifting device in the form of measured values, wherein by evaluating the detected measured values, handling instructions and/or handling-related information is generated for the operator of the vacuum lifting device and output via an output device, for example a display or the like.

Alternatively or additionally thereto, it is conceivable for the vacuum lifting device to be allocated a sensor system for the direct or indirect determination or assessment of the type and/or weight force of a transport item which will be or is gripped by the suction means of the vacuum lifting device, wherein the information determined or assessed by the sensor system is accordingly evaluated in an evaluation device in order to generate suitable handling instructions and/or handling-related information for the operator of the vacuum lifting device and to output this information via an output device.

This measure facilitates the handling of transport items using the vacuum lifting device since that which is output is handling instructions and/or handling-related information particularly individualized to the handling or to the operator which serves to support and guide the vacuum lifting device's operator in controlling the vacuum lifting device.

In particular, outputting the handling instructions and/or handling-related information can ensure the correct classification and proper handling of a transport item. Moreover, the operator of the vacuum lifting device can receive targeted information on a current handling operation, for example specification of a destination, a motion sequence, a handling speed or a load warning.

According to embodiments of the inventive vacuum lifting device, the sensor system comprises a scale, in particular an electromechanical scale, in order to directly determine the weight force of a transport item gripped by the suction means.

Alternatively or additionally thereto, it is conceivable for the sensor system to comprise a non-contact detection system designed to determine in particular the type of transport item which will be or is gripped by the suction means. Determining or assessing the type of transport item gripped or to be gripped by the suction means also indirectly establishes the weight force or a weight class of the transport item.

Different forms are conceivably possible for the non-contact detection system. For example, the non-contact detection system can comprise a scanning device for detecting the size and/or shape of a transport item to be gripped by the suction means, wherein the detection system is designed to assess or determine the weight force and/or type of transport item by means of the size and/or shape of the transport item to be gripped by the suction means.

It is also conceivable for the non-contact detection system to be a transmitter/receiver system for the automatic and contactless identification of a transport item gripped or to be gripped by the suction means.

Alternatively or additionally thereto, the non-contact detection system can also comprise a scanning device for scanning an identification assigned and preferably attached to a transport item gripped or to be gripped by the suction means.

The term “scanning device” as used here is to be understood as a data acquisition device in the form of a scanner or reader which is in particular designed to systematically and regularly scan or measure transport items. The scanning device is in particular designed to optomechanically detect the size and/or shape of a transport item to be gripped by the suction means.

Alternatively or additionally to such a scanning device, the non-contact detection system can comprise an RFID reader designed to read an identifier from a transponder assigned to a transport item gripped or to be gripped by the suction means and preferably attached to the transport item. Thus employed is a transmitter/receiver system technology for the automatic and contactless identification and localization of transport items via radio waves.

In the embodiment of the vacuum lifting device according to the invention, the scanning device and/or RFID reader is/are mounted in the area of the suction means. It is however also conceivable for the scanning device and/or RFID reader to be realized as a hand-held device to be manually operated by the operator of the vacuum lifting device.

According to preferential embodiments of the inventive vacuum lifting device, same is allocated a control device designed to control or select and preferably automatically set an operation or operating mode of the vacuum supply as a function of the type and/or weight force of a transport item gripped or to be gripped by the suction means as determined or assessed via the sensor system.

For example, the vacuum supply can comprise a side channel blower, whereby the control device of the vacuum lifting device is designed to vary the rotational speed of a blade impeller of the side channel blower or to set predefined or definable values as a function of the type and/or weight force of a transport item gripped or to be gripped by the suction means as determined or assessed via the sensor system so that the side channel blower is always operated optimally, which is advantageous with respect to the ongoing operating costs. In a side channel blower, air is sucked in via a rapidly rotating blade impeller and then pushed outward by centrifugal force, thereby creating a compression. The air then flows back inward again via the side channel and is further compressed between two further blades.

In this context, it is particularly conceivable for the vacuum supply to exhibit multiple side channel blowers which are preferably connected together in parallel. For example, the vacuum supply can comprise a first side channel blower and at least one further second side channel blower, wherein the control device of the vacuum lifting device is designed to activate the first side channel blower and/or the at least one further second side channel blower as a function of the type and/or weight force of a transport item gripped or to be gripped by the suction means as determined or assessed via the sensor system so as to optimally adapt the amount of vacuum “supplied” per unit of time to the transport item actually to be handled by the vacuum lifting device.

Alternatively or additionally thereto, the vacuum supply can also comprise a rotary piston pump, whereby in this case, the control device can be designed to vary the rotational speed of a pair of rotors of the rotary piston pump or to set predefined or definable values as a function of the type and/or weight force of a transport item gripped or to be gripped by the suction means as determined or assessed via the sensor system.

Specified according to a further aspect of the present invention is a vacuum lifting device comprising a sensor system for the direct or indirect determination or assessment of the centroid of an area or volume of the transport item to be gripped by the suction means. Expedient with this embodiment is for the vacuum lifting device to further comprise an optical pointing and/or sighting device, particularly in the form of a laser pointer, for the optically visualizing of the determined or assessed centroid of area or for projecting the determined or assessed centroid of volume onto the surface of the transport item to be gripped by the suction means. This measure can ensure that the operator of the vacuum lifting device always sets the suction means at the ideal point (centroid of area) of the transport item to be gripped.

According to a further aspect, the present invention relates to a vacuum lifting device to which a sensor system is assigned for determining a position of the suction means relative to a horizontal plane. An evaluation device is further preferably assigned in this embodiment which emits a relevant warning to the operator of the vacuum lifting device upon it being determined that the suction means is not horizontally aligned or respectively exceeds a predefined or definable angle to the horizontal plane. This predefined or definable angle is of course variably adjustable, and that as a function of the weight force or expected weight force of the transport item to be gripped by the suction means and/or the vacuum available to hold a gripped transport item. Doing so reliably prevents an unwanted detaching/disengaging of the transport item from the suction gripper.

According to a further aspect of the present invention, same relates to a vacuum lifting device comprising a sensor system for determining a momentary acceleration of the suction means. An evaluation and/or control device is preferably provided in this embodiment which activates the vacuum source allocated to the vacuum lifting device, or respectively the valve device assigned to the vacuum lifting device, subject to the determined momentary acceleration of the suction means. It can thereby be provided for the control device or the vacuum source respectively to be accordingly activated when the determined momentary acceleration of the suction means exceeds a previously defined critical value. This aspect is based on the knowledge that upon an unwanted detaching/separating of the transport item from the suction means, the suction means tends to spring upward, which could endanger the operator of the vacuum lifting device. There being a controlling effect on the valve device or the vacuum source when the momentary acceleration of the suction means exceeds a critical value can thus effectively prevent a dangerous situation.

It is in principle advantageous for the vacuum lifting device to comprise a storage device for storing information and data relevant to the operation of the vacuum lifting device. Doing so enables documenting the operation of the vacuum lifting device, particularly in order to be able to pre-plan maintenance intervals.

The storage device is in particular designed to permanently store preferably all of the data and information detected by the sensor system, whereby the storage device is designed to be at least partially readable, preferably via remote access.

Specified according to a further aspect of the present invention is a vacuum lifting device which comprises a sensor system for detecting the presence of an operator of the vacuum lifting device, wherein the vacuum lifting device is allocated a control device designed to activate the valve control of the vacuum lifting device and/or the vacuum supply of the vacuum lifting device as a function of the detection result of the sensor system.

The inventive vacuum lifting device preferably further comprises an operating device between the suction means and the end region of the suction hose, particularly in the form of a type of pistol grip, wherein the suction means is pivotably mounted to the operating device in preferably detachable or replaceable manner via a coupler.

The operating device can further comprise appropriate electrical switches or keys, in particular membrane keys, for activating corresponding valves of the valve control, wherein the respective electrical switches or keys are connected to the corresponding valve devices via an electrical line, and wherein the electrical lines are preferably integrated or accommodated in the wall of the suction line at least in some areas. The electrical switches or keys are preferably realized so as to be remotely controllable at least to some extent, particularly remotely controllable via a wireless remote control. Alternatively or additionally thereto, the operating device comprises at least one display or indicator in order to display information relevant to the operation of the vacuum lifting device.

A further aspect of the present invention relates to a system having a first vacuum lifting device of the aforementioned type and an optional crane system via which the vacuum lifting device can be positioned at different positions. The system further comprises at least one further second vacuum lifting device, particularly a further vacuum lifting device of the aforementioned type, whereby the first and the at least one second vacuum lifting device are connected to one another via a data transmission channel for transmitting data.

The first and the at least one second vacuum lifting device are thereby in particular designed to communicate and/or exchange data pursuant to the master/slave principle, wherein the first vacuum lifting device is designed to synchronize operation of the second vacuum lifting device to the operation of the first vacuum lifting device.

Lastly, the invention further relates to a method for operating such a system. This method provides for the operator of the system to preferably manually control the first vacuum lifting device via the operating device of the first vacuum lifting device, and that by activating the valve control of the first vacuum lifting device. The at least one second vacuum lifting device is thereby preferably automatically, and even more preferentially selectively automatically, controlled in synchronization with the first vacuum lifting device.

Embodiments of vacuum lifting devices according to the invention particularly afford an energy-saving function. This is able to be attained by way of the vacuum lifting device determining the weight force of the transport item. It is thereby conceivable for a side channel blower associated with the vacuum supply of the vacuum lifting device to be regulated within narrow limits. Alternatively or additionally thereto, the vacuum supply can also be allocated a rotary piston pump able to be regulated more precisely. It is thereby conceivable for part of the vacuum lifting device's height manipulation to be realized via changed volumetric flow. This thereby reduces energy consumption and noise level.

There may also be the possibility of defining a region of non-operation for the suction means/vacuum lifting device. If the vacuum lifting device/suction means is brought into this region of non-operation, it then switches off automatically or, respectively, the vacuum supply is automatically disconnected. The position of the suction means is to that end monitored accordingly.

According to preferential embodiments, the vacuum lifting device is allocated a storage device in order to be able to document the vacuum lifting device loads, and in particular vacuum lifting device suction means and/or suction hose loads, occurring over a predefined or definable period of time during which transport items are being handled during operation. These in particular include the weight force of the transport items handled during the time period and/or the handling period and/or the type of transport items handled over the period.

A further development of the present embodiment provides for the vacuum lifting device to further comprise an evaluation device designed to determine a total load change and/or a total load of the vacuum lifting device and in particular the suction means and/or suction hose of the vacuum lifting device over the predefined or definable period of time. The evaluation device is preferably further designed to output information relevant to maintenance and/or replacement of the suction means and/or suction hose, and to do so as a function of the determined total load change and/or determined total load.

This embodiment is based on the knowledge that particularly the suction means or even the suction hose of a vacuum lifting device needs to be replaced or serviced upon the tolerable loads totaling a strictly defined value. To date, inspection or maintenance has occurred on the basis of documenting the annual load changes, same being based on an estimation. This occasions great imprecision as it is not actually known exactly how many load changes have truly taken place and how high the load thereby was.

With the present invention, the overall collective load is preferably logged, which enables a greater degree of supporting structure utilization. This thereby again enables saving on weight or respectively energy and in particular increasing service life. It is further possible to even identify in advance when the components of the vacuum lifting device need to be replaced. A replacement can thus be procured in advance, downtimes minimized, and process reliability significantly increased.

A further development of the inventive vacuum lifting device provides for the vacuum lifting device to comprise an evaluation device designed to check, on the basis of the determined or assessed type and/or the basis of the weight force of the transport item which will be or is gripped by the suction means, whether the components of the vacuum lifting device and in particular the suction means and/or the suction hose of the vacuum lifting device are even designed for the loads occurring during the handling of the transport item in the first place. This relates for example to the gripping capacity of the suction means and/or the lifting capacity of the suction hose.

According to one advantageous further development of the latter embodiment, the evaluation device is designed to deactivate the vacuum lifting device or components thereof and/or emit a relevant warning when the check reveals that the components of the vacuum lifting device and in particular the suction means and/or suction hose of the vacuum lifting device are not designed in respect of the loads which occur during the handling of the transport item.

The presence of the safety factor required for handling a transport item, such as e.g. the effective cross section of the suction means and/or the effective cross section of the suction hose, can inasmuch be checked. For example, using a suction means which has too small of a suction area can result in an uncontrolled load crash. This threat can be inherently excluded if the vacuum lifting device only works when the required safety factors are present.

A further development of the inventive vacuum lifting device provides for same to be allocated an optical display particularly for displaying discrete information and/or data regarding the operation of the vacuum lifting device. Alternatively or additionally, the optical display is designed to in particular display discrete information about a transport item to be handled by the vacuum lifting device.

Said optical display can for example be mounted in the periphery of the vacuum lifting device operator's field of view such as e.g. a suitable eyewear frame. In addition to the discrete display of information on the optical display, further information can also be displayed by way of an image taken for example by the suction means using an integrated digital camera.

Further embodiments of the inventive vacuum lifting device provide for the suction hose and the suction means to be able to exchange data and/or information with one another, in particular bidirectionally, via a communication device. This thereby enables an optimal and in particular automatic synchronizing of these two fundamental vacuum lifting device components (suction means and suction hose). Thus, it is for example conceivable for the vacuum lifting device to only be able to be activated when an appropriate and suitable suction means is connected to the suction hose. This check is preferably conducted automatically or selectively automatically via the particularly bidirectional communication device.

In other words, according to the latter embodiment, the suction hose can for example communicate with the suction gripper in either read-only manner, by way of a QR code or similar technologies, or in read/write manner, for example by way of an RFID chip or comparable technology.

1. A vacuum lifting device comprising:
a suction line extending between a vacuum connection of a vacuum supply and an outlet opening;
a suction means configured to sealingly engage with a surface of a transport item;
wherein the suction means is attached to one side of the suction line
wherein the suction means delimits the outlet opening;
a variable-length suction hose configured to limit sections of the suction line between the suction means and the vacuum connection; and
a valve control configured to set a negative pressure in the variable-length suction hose as well as influence a free flow cross-section of the suction line within a section of line between the variable-length suction hose and the outlet opening;
wherein the valve control is adjustable between a closed position for interrupting the line section of line between the variable-length suction hose and the outlet opening and an open position for unblocking the section of line between the variable-length suction hose and the outlet opening,
wherein the vacuum lifting device comprises a sensor system configured to directly determine or indirectly determine at least one of a type or a weight force of a transport item gripped by the suction means.

2. The vacuum lifting device according to claim 1,
wherein the sensor system comprises a scale configured to directly determine the weight force of the transport item gripped by the suction means.

3. The vacuum lifting device according to claim 1,
wherein the sensor system comprises a non-contact detection system configured to determine the type of the transport item gripped by the suction means.

4. The vacuum lifting device according to claim 3,
wherein the non-contact detection system comprises a scanning device configured to detect at least one of a size or a shape of the transport item to be gripped by the suction means; and
wherein at least one of:
i) the non-contact detection system is configured to determine at least one of the weight force or type of transport item by at least one of the size or the shape of the transport item to be gripped by the suction means;
ii) the non-contact detection system comprises a scanning device configured to scan an identification attached to the transport item gripped by the suction means;
iii) the non-contact detection system is a transmitter/receiver system configured for an automatic and contactless identification of the transport item gripped by the suction means; or
iv) the non-contact detection system comprises an RFID reader configured to read out an identifier from a transponder assigned to the transport item gripped by the suction means; and
wherein the transponder is attached to the transport item.

5. The vacuum lifting device according to claim 4,
wherein at least one of:
i) at least one of the scanning device, the transmitter/receiver system, or the RFID reader is mounted on or in an area of the suction means; or
ii) at least one of the scanning device or the transmitter/receiver system and/or RFID reader is/are realized as a hand-held device to be manually operated by an operator of the vacuum lifting device.

6. The vacuum lifting device according to claim 1,
wherein the vacuum lifting device is allocated a control device,
wherein the control device is configured to control or select and automatically set an operation of the vacuum supply as a function of at least one of the type or the weight force of the transport item gripped by the suction means as determined via the sensor system.

7. The vacuum lifting device according to claim 6,
wherein the vacuum supply comprises a side channel blower, and
wherein the control device is configured to vary a rotational speed of a blade impeller of the side channel blower or to set predefined values as a function of at least one of the type or the weight force of the transport item gripped by the suction means as determined via the sensor system.

8. The vacuum lifting device according to claim 6,
wherein the vacuum supply comprises a first side channel blower and at least one further second side channel blower,
wherein the control device is configured to activate at least one of the first side channel blower or the at least one further second side channel blower as a function of at least one of the type or the weight force of the transport item gripped by the suction means as determined via the sensor system, and wherein the first side channel blower and the at least one further second side channel blower are connected together in parallel.

9. The vacuum lifting device according to claim 6,
wherein the vacuum supply comprises a rotary piston pump, and
wherein the control device is configured to vary a rotational speed of a pair of rotors of the rotary piston pump or to set predefined values as a function of at least one of the type or the weight force of the transport item gripped by the suction means as determined via the sensor system.

10. The vacuum lifting device according to claim 1,
wherein the vacuum lifting device comprises a sensor system configured to directly determine or indirectly determine a centroid of an area or volume of the transport item to be gripped by the suction means, and
wherein the vacuum lifting device further comprises at least one of an optical pointing device or a sighting device configured to optically visualize the determined centroid of area or project the determined centroid of volume onto a surface of the transport item to be gripped by the suction means.

11. The vacuum lifting device according to claim 1,
wherein the vacuum lifting device comprises a sensor system configured to determine a position of the suction means relative to a horizontal plane.

12. The vacuum lifting device according to claim 1,
wherein the vacuum lifting device comprises a sensor system configured to determine a momentary acceleration of the suction means.

13. The vacuum lifting device according to claim 1,
wherein the vacuum lifting device comprises a control device configured to activate at least one of the valve control of the vacuum lifting device or the vacuum supply of the vacuum lifting device as a function of at least one of:
i) a determined position of the suction means relative to a horizontal plane;
ii) a determined momentary acceleration of the suction means; or
iii) at least one of a determined type or the weight force of the transport item gripped by the suction means.

14. The vacuum lifting device according to claim 1,
wherein the vacuum lifting device comprises a storage device for storing information and data relevant to an operation of the vacuum lifting device, wherein the storage device is configured to permanently store all of the data and information detected by the sensor system, and
wherein the storage device is configured to be at least partially readable via remote access.

15. The vacuum lifting device according to claim 1,
wherein the vacuum lifting device comprises a sensor system configured to detect a presence of an operator of the vacuum lifting device, wherein the vacuum lifting device comprises a control device configured to activate at least one of the valve control of the vacuum lifting device or the vacuum supply of the vacuum lifting device as a function of a detection result of the sensor system.

16. The vacuum lifting device according to claim 1,
wherein an operating device is further provided between the suction means and an end region of the suction hose,
wherein the suction means is detachably and pivotably mounted to the operating device via a coupler.

17. The vacuum lifting device according to claim 16,
wherein the operating device comprises electrical keys, configured to activate corresponding valves of the valve control,
wherein the electrical keys are connected to the corresponding valves via an electrical line, and
wherein the electrical line is integrated in at least a portion of a wall of the suction line.

18. The vacuum lifting device according to claim 17,
wherein the electrical keys are remotely controllable via a wireless remote control.

19. The vacuum lifting device according to claim 16,
wherein the operating device comprises at least one display configured to display information relevant to an operation of the vacuum lifting device.

20. The vacuum lifting device according to claim 1,
wherein the vacuum lifting device comprises a storage device for documenting a vacuum lifting device load occurring over a predefined or definable period of time during which transport items are being handled during operation.

21. The vacuum lifting device according to claim 20,
further comprising an evaluation device configured to determine at least one of a total load change or a total load of the vacuum lifting device based on documented loads, and
wherein the evaluation device is also configured to output information relevant to at least one of a maintenance or a replacement of at least one of the suction means or the suction hose as a function of at least one of the determined total load change or the determined total load.

22. The vacuum lifting device according to claim 1,
wherein the vacuum lifting device comprises an evaluation device configured to check, based on at least one of the determined type or the determined weight force of the transport item gripped by the suction means, whether components of the vacuum lifting device are designed for loads which occur during handling of the transport item.

23. The vacuum lifting device according to claim 22,
wherein the evaluation device is configured to deactivate the vacuum lifting device or components thereof and/or emit a relevant warning when the check reveals that the components of the vacuum lifting device are not designed in respect of the loads which occur during the handling of the transport item.

24. The vacuum lifting device according to claim 1,
wherein the vacuum lifting device comprises an optical display configured to display at least one of discrete information or data regarding an operation of the vacuum lifting device.

25. The vacuum lifting device according to claim 1,
wherein the suction hose and the suction means are able to exchange data with one another via a communication device.

26. A system comprising:
a first vacuum lifting device according to claim 1; and
a second vacuum lifting device according to claim 1,
wherein the first vacuum lifting device and the second vacuum lifting device are connected to one another via a data transmission channel for transmitting data.

27. The system according to claim 26,
wherein the first vacuum lifting device and the second vacuum lifting device are configured to at least one of communicate or exchange data with one another,
wherein the first vacuum lifting device is configured to synchronize operation of the second vacuum lifting device to the operation of the first vacuum lifting device.

28. A method for operating a system according to claim 26,
wherein the first vacuum lifting device is configured to be manually controlled by the system operator via the operating device of the first vacuum lifting device by way of activating the valve control of the first vacuum lifting device, and
wherein the second vacuum lifting device is configured to be automatically controlled in synchronization with the first vacuum lifting device.
